(19) United States
(12) Patent Application Publication
(10) Pub. No.: US 2019/0056975 A1
(43) Pub. Date: Feb. 21, 2019

(54) VIRTUALIZED NETWORK FUNCTION MANAGER DETERMINING METHOD AND NETWORK FUNCTIONS VIRTUALIZATION ORCHESTRATOR

(71) Applicant: HUAWEI TECHNOLOGIES CO., LTD., SHENZHEN (CN)

(72) Inventors: Fang YU, Beijing (CN); Xu YANG, Beijing (CN); Haitao XIA, Beijing (CN)

(21) Appl. No.: 16/168,493

(22) Filed: Oct. 23, 2018

Related U.S. Application Data
(63) Continuation of application No. PCT/CN2016/080333, filed on Apr. 27, 2016.

(51) Int. Cl. G06F 9/50; H04L 12/24; G06F 9/455

(52) U.S. Cl. CPC G06F 9/5077; H04L 41/0896; G06F 2009/45575; G06F 9/45558; G06F 2009/45595; H04L 41/0893

(57) ABSTRACT

Embodiments of the present disclosure provide a VNFM determining method and a network functions virtualization orchestrator. The method includes: receiving, by an NFVO, a first VNF instantiation request; determining, according to the first VNF instantiation request from VNFMs in a management domain of the NFVO, a VNFM managing the to-be-instantiated VNF; and sending a second VNF instantiation request to the determined VNFM, where the second VNF instantiation request is used to request the determined VNFM to instantiate the to-be-instantiated VNF. A correct VNFM is selected for the VNF, thereby ensuring that VNF deployment and life cycle management are performed correctly and highly efficiently.

### CROSS-REFERENCE TO RELATED APPLICATIONS

This application is a continuation of International Patent Application No. PCT/CN2016/080333, filed on Apr. 27, 2016. The disclosure of the aforementioned application is hereby incorporated by reference in the entity.

### TECHNICAL FIELD

The present disclosure relates to communications technologies, and in particular, to a virtualized network function manager (VNF Manager, VNFM) determining method and a network functions virtualization orchestrator.

### BACKGROUND

In Network Functions Virtualization (NFV), software processing of massive functions is born by using general purpose hardware and a virtualization technology, to reduce expensive equipment costs of a network. Software and hardware decoupling and functional abstraction may be used, so that a network device function is no longer dependent on dedicated hardware, resources can be fully and flexibly shared, a new service is quickly developed and deployed, and automatic deployment, flexible scaling, fault isolation, self-healing, and the like are performed based on an actual service requirement.

The NFV system includes management and orchestration (MANO). The MANO includes a network functions virtualization orchestrator (NFV Orchestrator, NFVO) and a virtualized network function manager (VNFM). The VNFM is responsible for a virtualized network function (VNF) instance life cycle management such as a time to start, a time to live, and VNF operating status information. Currently, the NFV system is in an initial phase, and therefore an NFV system structure is relatively simple, and there is only one VNFM in a management domain of each NFVO. When receiving a VNF instantiation request, the NFVO directly forwards the VNF instantiation request to the VNFM.

However, with expansion of the NFV system, a quantity of VNFMs in the management domain of each NFVO definitely increases. In this case, when the NFVO receives the VNF instantiation request, VNF instantiation cannot be completed.

### SUMMARY

Embodiments of the present disclosure provide a VNFM determining method and a network functions virtualization orchestrator, so that when receiving a VNF instantiation request, the NFVO can determine a VNFM that is configured to manage a to-be-instantiated VNF.

A first aspect of the present disclosure provides a VNFM determining method, including: when receiving a first VNF instantiation request that is used to request to instantiate a to-be-instantiated VNF, determining, by the NFVO according to the first VNF instantiation request from VNFMs in a management domain of the NFVO, a VNFM managing the to-be-instantiated VNF; and sending a second VNF instantiation request to the determined VNFM, where the second VNF instantiation request is used to request the determined VNFM to instantiate the to-be-instantiated VNF, so as to implement selection of a correct VNFM for the VNF, thereby ensuring that VNF deployment and life cycle management are performed correctly and highly efficiently.

In a possible implementation of the first aspect of the present disclosure, the NFVO obtains, based on identification information of a virtualized network function descriptor (VNFD) included in the first VNF instantiation request, the VNFD corresponding to the identification information of the VNFD; and determines, from the VNFMs in the management domain of the NFVO based on the identification information of the VNFM managing the to-be-instantiated VNF included in the VNFD, that a VNFM corresponding to the identification information of the VNFM is the VNFM managing the to-be-instantiated VNF. The VNFM is determined based on the identification information of the VNFM that is specified by a vendor of the VNF in the VNFD, and therefore, it can be ensured that a capability of the VNFM managing the VNF meets all requirements of the vendor of the VNF, thereby ensuring that VNF deployment and life cycle management are performed correctly and highly efficiently.

Optionally, the identification information of the VNFM includes a first identifier of the VNFM, where the first identifier is used to uniquely identify the VNFM in the management domain of an operator; or the identification information of the VNFM includes a second identifier of the VNFM, where the second identifier is a universally unique identifier (UUID), and the second identifier is used to uniquely identify the VNFM globally.

In a possible implementation of the first aspect of the present disclosure, the NFVO obtains, based on identification information of a VNFD included in the first VNF instantiation request, the VNFD corresponding to the identification information of the VNFD; and determines, based on a third identifier of the VNFM managing the to-be-instantiated VNF included in the VNFD and vendor information of the to-be-instantiated VNF from the VNFMs in the management domain of the NFVO, the VNFM managing the to-be-instantiated VNF, where the third identifier is used to uniquely identify the VNFM in a management domain of the vendor. The VNFM is determined based on the identification information of the VNFM that is specified by a vendor of the VNF in the VNFD and the vendor information, and therefore, it can be ensured that a capability of the VNFM managing the VNF meets all requirements of the vendor of the VNF, thereby ensuring that VNF deployment and life cycle management are performed correctly and highly efficiently.

In a possible implementation of the first aspect of the present disclosure, the NFVO obtains, based on identification information of a VNFD included in the first VNF instantiation request, the VNFD corresponding to the identification information of the VNFD; and determines, from the VNFMs in the management domain of the NFVO based on the type of the to-be-instantiated VNF and the vendor identification information of the to-be-instantiated VNF that are included in the VNFD, and a vendor of each VNFM in the management domain of the NFVO and a type of a VNF managed by each VNFM that are pre-obtained, the VNFM managing the to-be-instantiated VNF. The VNFM is determined based on the VNF type and the VNF vendor, and therefore, it can be ensured that the VNF type that can be managed by the selected VNFM matches the VNF type, and VNF deployment and VNF life cycle management are performed correctly and efficiently, and in addition, the NFVO may select one VNFM based on internal settings from several VNFMs meeting the requirements to implement load balancing between VNFMs.

In a possible implementation of the first aspect of the present disclosure, the NFVO obtains, based on identification information of a VNFD included in the first VNF instantiation request, the VNFD corresponding to the identification information of the VNFD; and determines, from the VNFMs in the management domain of the NFVO based on the type of the to-be-instantiated VNF included in the VNFD and the type of the VNF managed by each VNFM in the management domain of the NFVO that is pre-obtained, that a VNFM managing the VNF whose type is the same as that of the to-be-instantiated VNF is the VNFM managing the to-be-instantiated VNF. The method can ensure that in a G-VNFM scenario, a capability of the VNFM selected for the VNF matches the VNF type, and VNF life cycle management is performed correctly and efficiently.

Optionally, the type of the VNF managed by the VNFM in the management domain of the NFVO is pre-configured; or the NFVO queries, from each VNFM in the management domain, the type of the VNF managed by each VNFM; or the NFVO receives a type that is of a VNF managed by each VNFM and that is reported by each VNFM.

In a possible implementation of the first aspect of the present disclosure, the NFVO obtains, by using an operation support system (OSS), a correspondence between each VNFM in the management domain of the NFVO and the VNF managed by each VNFM; and determines, based on the correspondence between each VNFM in the management domain of the NFVO and the VNF managed by each VNFM, that a VNFM corresponding to the to-be-instantiated VNF is the VNFM managing the to-be-instantiated VNF. Based on the correspondence that is between the VNFM and the VNF and that is stored by the OSS, it may be ensured that the VNFM selected by the NFVO for the to-be-instantiated VNF meets service and virtualization deployment requirements of the OSS on the operator.

Optionally, the NFVO sends a VNFM capability query request to the OSS, where the VNFM capability query request is used to request to query the correspondence between each VNFM in the management domain of the NFVO and the VNF managed by each VNFM, and then receives a query response returned by the OSS to obtain the correspondence from the query response; or the NFVO receives the correspondence that is between each VNFM in the management domain of the NFVO and the VNF managed by each VNFM and that is reported by the OSS.

In a possible implementation of the first aspect of the present disclosure, the NFVO selects, according to the first VNF instantiation request from VNFMs in the management domain of the NFVO, a VNFM supporting bulk granting as the VNFM managing the to-be-instantiated VNF. The selected VNFM can support the bulk granting, and has performed the life cycle management on the VNF for several times, thereby improving VNF life cycle management efficiency, and ensuring consistency of policies of the NFVO and the VNFM.

Optionally, there may be a plurality of VNFMs supporting the bulk granting in the NFVO. The NFVO first determines, from VNFMs in the management domain of the NFVO, at least two backup VNFMs supporting the bulk granting; and then selects, based on an available capacity of the at least two backup VNFMs, a VNFM from the at least two backup VNFMs as the VNFM managing the to-be-instantiated VNF. Load balancing between VNFMs is implemented when a VNFM is selected based on the capacity from several VNFMs meeting the requirement.

Before selecting the VNFM based on a bulk granting supporting capability, the NFVO further receives a bulk granting capability support notification sent by the VNFM in the management domain of the NFVO; or queries, from each VNFM in the management domain of the NFVO, whether each VNFM supports the bulk granting capability.

In a possible implementation of the first aspect of the present disclosure, the NFVO obtains, based on identification information of a VNFD included in the first VNF instantiation request, the VNFD corresponding to the identification information of the VNFD; and determines, from the VNFMs in the management domain of the NFVO based on a VNFD description language included in the VNFD and a VNFD description language that is pre-obtained and that is supported by each VNFM in the management domain of the NFVO, that a VNFM supporting the VNFD description language is the VNFM managing the to-be-instantiated VNF. The determined VNFM can support the VNFD description language, and therefore, it can be ensured that the VNFM reads and understands content described by the VNFD, and obtains a VNF deployment requirement, thereby ensuring that VNF deployment and life cycle management are performed correctly.

Before selecting the VNFM based on the VNFD description language, the NFVO queries, from each VNFM in the management domain of the NFVO, the VNFD description language supported by each VNFM; or the NFVO receives the VNFD description language that is reported by each VNFM and that is supported by each VNFM.

In the first aspect and possible implementations of the first aspect, after determining, for the VNF, the VNFM configured for management, the NFVO may further store a correspondence between an identifier of the to-be-instantiated VNF and an identifier of the determined VNFM. If the NFVO obtains the VNFD, the NFVO may further store a correspondence between an identifier of the VNFD and the identifier of the determined VNFM.

A second aspect of the present disclosure provides an NFVO, where the NFVO includes: a receiving module, a determining module, and a sending module. The receiving module is configured to receive a first VNF instantiation request; the determining module is configured to determine, from VNFMs in a management domain of the NFVO according to the first VNF instantiation request received by the receiving module, a VNFM managing the to-be-instantiated VNF; and the sending module is configured to send a second VNF instantiation request to the VNFM determined by the determined module, where the second VNF instantiation request is used to request to instantiate the to-be-instantiated VNF. The NFVO can select a correct VNFM for the VNF, so as to ensure that VNF deployment and life cycle management are performed correctly and highly efficiently.

The NFVO provided in the second aspect of the present disclosure may be configured to perform the VNFM determining method provided in the first aspect of the present disclosure. An implementation and a technical effect thereof are similar to those of the VNFM determining method, and reference may be made to related description of the foregoing first aspect and possible implementations of the first aspect. Details are not described herein again.

A third aspect of the present disclosure provides an NFVO, and the NFVO includes: a processor, a memory, and a communications interface. The memory is configured to store a program, and the communications interface and the memory are connected to the processor by using a bus. The communications interface is configured to receive a first virtualized network function VNF instantiation request; the processor is configured to determine, according to the first VNF instantiation request from VNFMs in a management domain of the NFVO, a VNFM managing a to-be-instantiated VNF; and the communications interface is further configured to send a second VNF instantiation request to the determined VNFM, where the second VNF instantiation request is used to request to instantiate the to-be-instantiated VNF.

In a possible implementation of the third aspect of the present disclosure, the processor is configured to: obtain, based on identification information of a VNFD included in the first VNF instantiation request, the VNFD corresponding to the identification information of the VNFD; and determine, from the VNFMs in the management domain of the NFVO based on the identification information of the VNFM managing the to-be-instantiated VNF included in the VNFD, that a VNFM corresponding to the identification information of the VNFM is the VNFM managing the to-be-instantiated VNF.

In a possible implementation of the third aspect of the present disclosure, the processor is configured to: obtain, based on identification information of a VNFD that is included in the first VNF instantiation request and that is used to instantiate the to-be-instantiated VNF, the VNFD corresponding to the identification information of the VNFD; and determine, based on a third identifier of the to-be-instantiated VNF included in the VNFD and vendor information of the to-be-instantiated VNF from the VNFMs in the management domain of the NFVO, the VNFM managing the to-be-instantiated VNF, where the third identifier is used to uniquely identify the VNFM of the to-be-instantiated VNF in a management domain of the vendor.

In a possible implementation of the third aspect of the present disclosure, the processor is configured to: obtain, based on identification information of a VNFD that is included in the first VNF instantiation request and that is used to instantiate the to-be-instantiated VNF, the VNFD corresponding to the identification information of the VNFD; and determine, from the VNFMs in the management domain of the NFVO based on a type of the to-be-instantiated VNF and the vendor identification information of the to-be-instantiated VNF that are included in the VNFD, and a vendor of each VNFM in the management domain of the NFVO and a type of a VNF managed by each VNFM that are pre-obtained, the VNFM managing the to-be-instantiated VNF.

In a possible implementation of the third aspect of the present disclosure, the processor is configured to: obtain, based on identification information of a VNFD that is included in the first VNF instantiation request and that is used to instantiate the to-be-instantiated VNF, the VNFD corresponding to the identification information of the VNFD; and determine, from the VNFMs in the management domain of the NFVO based on the type of the to-be-instantiated VNF included in the VNFD and the type of the VNF managed by each VNFM in the management domain of the NFVO that is pre-obtained, that a VNFM managing the VNF whose type is the same as that of the to-be-instantiated VNF is the VNFM managing the to-be-instantiated VNF.

In a possible implementation of the third aspect of the present disclosure, the processor is configured to: obtain, by using an OSS, a correspondence between each VNFM in the management domain of the NFVO and the VNF managed by each VNFM; and determine, based on the correspondence between each VNFM in the management domain of the NFVO and the VNF managed by each VNFM, that a VNFM corresponding to the to-be-instantiated VNF is the VNFM managing the to-be-instantiated VNF.

In a possible implementation of the third aspect of the present disclosure, the processor is configured to: select, according to the first VNF instantiation request from VNFMs in the management domain of the NFVO, a VNFM that supports bulk granting and that has performed life cycle management on the VNF for several times as the VNFM managing the to-be-instantiated VNF.

In a possible implementation of the third aspect of the present disclosure, the processor is configured to: obtain, based on identification information of a VNFD that is included in the first VNF instantiation request and that is used to instantiate the to-be-instantiated VNF, the VNFD corresponding to the identification information of the VNFD; and determine, from the VNFMs in the management domain of the NFVO based on a VNFD description language included in the VNFD and a VNFD description language that is pre-obtained and that is supported by each VNFM in the management domain of the NFVO, that a VNFM supporting the VNFD description language is the VNFM managing the to-be-instantiated VNF.

In a possible implementation of the third aspect of the present disclosure, the memory is further configured to: store a correspondence between an identifier of the to-be-instantiated VNF and an identifier of the VNFM determined by the determining module, and store a correspondence between an identifier of the VNFD and the identifier of the VNFM determined by the determining module.

The NFVO provided in the third aspect of the present disclosure may be configured to perform the VNFM determining method provided in the first aspect of the present disclosure. An implementation and a technical effect thereof are similar to those of the VNFM determining method, and reference may be made to related description of the foregoing first aspect and possible implementations of the first aspect. Details are not described herein again.

According to the VNFM determining method and the network functions virtualization orchestrator provided in the embodiments of the present disclosure, when receiving the first VNF instantiation request that is used to request to instantiate the to-be-instantiated VNF, the NFVO determines, according to the first VNF instantiation request from the VNFMs in the management domain of the NFVO, the VNFM managing the to-be-instantiated VNF; and sends the second VNF instantiation request to the determined VNFM, where the second VNF instantiation request is used to request to instantiate the to-be-instantiated VNF, so as to implement selection of a correct VNFM for the VNF, thereby ensuring that VNF deployment and life cycle management are performed correctly and highly efficiently.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show some embodiments of the present disclosure, and a person of ordinary skill in the art may derive other drawings from these accompanying drawings without creative efforts.

FIG. 1 is a schematic architectural diagram of an NFV system;

FIG. 2 is a flowchart of a VNFM determining method according to Embodiment 1 of the present disclosure;

FIG. 3 is a flowchart of a VNFM determining method according to Embodiment 2 of the present disclosure;

FIG. 4 is a flowchart of a VNFM determining method according to Embodiment 3 of the present disclosure;

FIG. 5 is a flowchart of a VNFM determining method according to Embodiment 4 of the present disclosure;

FIG. 6 is a flowchart of a VNFM determining method according to Embodiment 5 of the present disclosure;

FIG. 7 is a flowchart of a VNFM determining method according to Embodiment 6 of the present disclosure;

FIG. 8 is a flowchart of a VNFM determining method according to Embodiment 7 of the present disclosure;

FIG. 9 is a schematic structural diagram of an NFVO according to Embodiment 8 of the present disclosure; and

FIG. 10 is a schematic structural diagram of an NFVO according to Embodiment 9 of the present disclosure.

### DESCRIPTION OF EMBODIMENTS

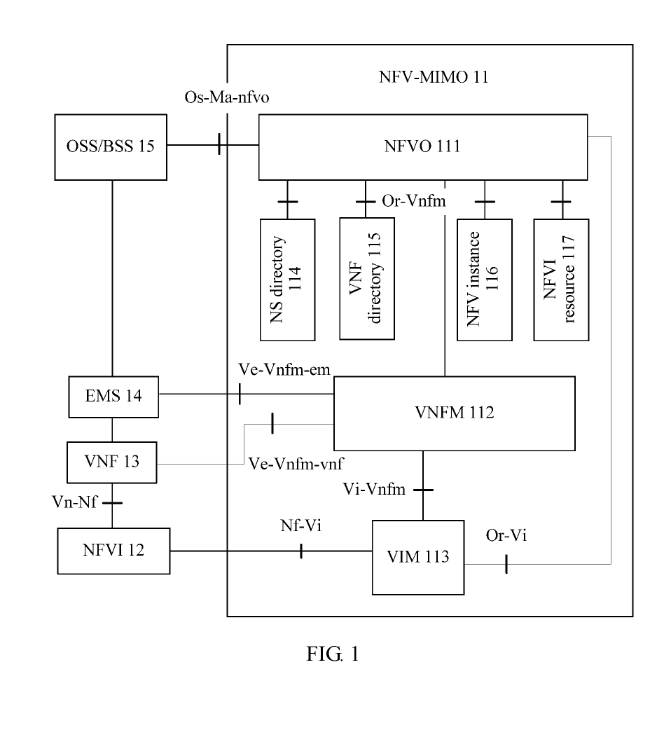

The method of the embodiments of the present disclosure is applied to an NFV system. FIG. 1 is a schematic architectural diagram of the NFV system. As shown in FIG. 1, the NFV system architecture includes: an NFV-MIMO 11, a network function virtualization infrastructure (NFVI) 12, a virtualized network function (VNF) 13, an element management system (EMS) 14, and an operation support system/business support system (OSS/BSS) 15. There may be one or more VNFs 13, EMSs 14, and OSSs/BSSs 15.

The NFV-MANO 11 may include an NFVO 111, one or more VNFMs 112, and one or more virtualized infrastructure managers (VIM) 113. An NFVO is responsible for network service (NS) life cycle management based on an OSS/BSS service request, orchestrating and managing resources to implement an NFV service and monitor a VNF or NFVI resource and running status information thereof in real time. Data of the NFV-MANO 11 is stored in four repositories: an NS directory 114, a VNF directory 115, an NFV instance 116, and an NFVI resource 117. The NS directory 114 includes a loaded NSD. The VNF directory 115 includes loaded a VNF package. The NFV instance 116 includes a running NS instance and VNF instance. The NFVI resource 117 includes an NFVI resource state such as an available/reserved/allocated NFVI resource.

The VNFM 112 may be used to manage one or more VNFs 13, and perform various management functions such as initiating, updating, querying, and/or terminating the VNF 13. The VIM 113 may be used to control and manage the VNF 13.

The NFVI 12 may include: a hardware resource layer including computing hardware, storage hardware, and network hardware; a virtualization layer; and a virtual resource layer including virtual computing (for example, a virtual machine), virtual storage, and a virtual network.

The computing hardware at the hardware resource layer may be a dedicated processor or a general purpose processor that is configured to provide processing and computing functions, for example, a central processing unit (CPU). The storage hardware is configured to provide a storage capability, for example, a disk or network attached storage (NAS). The network hardware may be a switch, a router, and/or another network device.

The virtualization layer in the NFVI 12 is used to: abstract a hardware resource of the hardware resource layer, decouple the VNF 13 and a physical layer to which the hardware resource belongs, and provide a virtual resource for the VNF.

The virtual resource layer may include virtual computing, virtual storage, and a virtual network. The virtual computing and the virtual storage may be provided for the VNF 13 in a form of a virtual machine or another virtual container. For example, one VNF includes one or more virtual machines. The virtualization layer forms the virtual network by using abstract network hardware. The virtual network is used to implement communication between a plurality of virtual machines or between a plurality of virtual containers of another type that bear the VNF. Creation of the virtual network may be implemented by using a technology such as a virtual LAN (VLAN), a virtual private LAN service (VPLS), a Virtual Extensible Local Area Network (VXLAN), or a Network Virtualization using Generic Routing Encapsulation (NVGRE).

The VNF 13 is corresponding to a physical network function (PNF) in a conventional non-virtualization network, for example, a virtualized evolved packet core (EPC) node. The virtualized EPC node includes: a mobility management entity MME), a serving gateway (SGW), a packet data network gateway (PGW), and the like. A functional behavior and a state of the network are unrelated to whether the network is virtualized. In the NFV system, the VNF and the PNF have the same functional behavior and external interface.

The EMS 14 may be configured to manage one or more VNFs 13, and mainly performs, for the VNF 13, conventional fault management, configuration management, accounting management, performance management, security management (FCAPS) functions.

The OSS/BSS 15 mainly provides, for a telecommunications service operator, integrated network management and service operation functions, including network management (for example, fault monitoring and network information collection), accounting management, customer service management, and the like.

The NFV system mainly includes the following related interfaces:

Ve-Vnfm: used for VNF life cycle management and exchanging configuration information;

Or-Vnfm: used to request a resource for VNF life cycle management, send configuration information, and collect state information;

Vi-Vnfm: used for a resource allocation request, virtualization resource configuration, and exchanging state information;

Or-Vi: used for a resource reservation or allocation request, virtualization resource configuration, and exchanging state information;

Nf-Vi: used for resource allocation, exchanging virtualization resource state information, and hardware resource configuration;

Vn-Nf: used by an NFVI to provide an actual execution environment for a VNF;

VI-Ha: A virtualization layer requests a hardware resource and collects hardware resource state information by using the interface;

Oi-Vi: used for a resource reservation request, a resource allocation request, virtualization hardware configuration, and exchanging state information;

Se-Ma: used to retrieve VNF forwarding graph information, service-related information, and the like;

Os-Ma: used for VNF life cycle management, NS life cycle management, policy management, and the like.

In actual NFV-MANO application, two VNFM deployment scenarios are supported: generic NVFM (G-VNFM) and specific (S-VNFM). The G-VNFM may manage different types of VNFs provided by different vendors. Both the S-VNFM and the VNF are provided by the vendor, and the S-VNFM may manage only VNFs provided by a same vendor. For one NFVO, there may be a plurality of VNFMs in a management domain of the NFVO. The plurality of VNFMs may include the G-VNFM and the S-VNFM. When there are a plurality of VNFMs in the management domain of the NFVO, how the NFVO selects a correct VNFM for the VNF is not specified in the prior art. If the NFVO cannot select a correct VNFM for the VNF, a VNF instantiation operation cannot be completed.

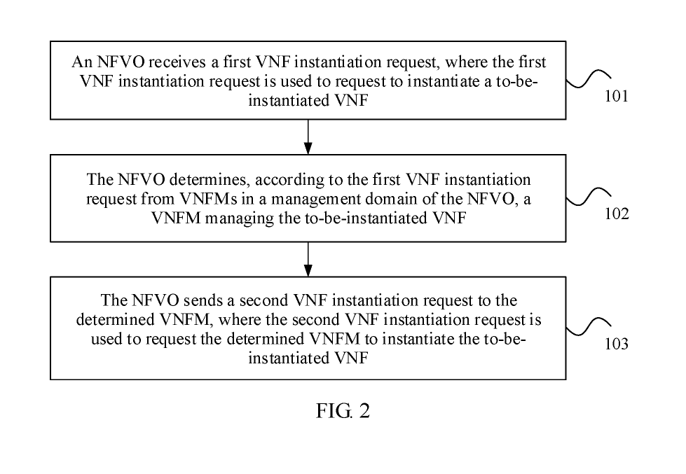

Embodiment 1 of the present disclosure provides a VNFM determining method. FIG. 2 is a flowchart of the VNFM determining method according to Embodiment 1 of the present disclosure. As shown in FIG. 2, the method provided in this embodiment may include the following operations.

Operation 101: An NFVO receives a first VNF instantiation request, where the first VNF instantiation request is used to request to instantiate a to-be-instantiated VNF.

The VNF instantiation request may be sent by an OSS or a BSS. The VNF instantiation request may include some feature parameters of the to-be-instantiated VNF, for example, an identifier of the to-be-instantiated VNF, a type of the to-be-instantiated VNF, and virtual resources required by the to-be-instantiated VNF (a computing resource, a storage resource, and a network resource).

Operation 102: The NFVO determines, according to the first VNF instantiation request from VNFMs in a management domain of the NFVO, a VNFM managing the to-be-instantiated VNF.

In this embodiment, the management domain of the NFVO includes one or more VNFMs, and the NFVO selects a correct VNFM for the to-be-instantiated VNF based on information included in the instantiation request. Different VNFMs manage different types of VNFs, and an S-VNFM can manage a VNF only from a same vendor as that of the S-VNFM. If a same vendor provides a plurality of S-VNFMs, the plurality of S-VNFMs provided by the same vendor separately manage different types of VNFMs. A correct VNFM needs to be selected for the to-be-instantiated VNF based on the type, the vendor, or other parameters of the to-be-instantiated VNF.

In an implementation, the VNF instantiation request carries some information that is used by the NFVO to determine the VNFM managing the to-be-instantiated VNF. The NFVO determines, based on the information carried in the VNF instantiation request, the VNFM managing the to-be-instantiated VNF. In another implementation, the VNF instantiation request does not carry the information that is used by the NFVO to determine the VNFM managing the to-be-instantiated VNF. The VNF instantiation request only triggers the NFVO to select, in a preset manner, the VNFM managing the to-be-instantiated VNF.

Operation 103: The NFVO sends a second VNF instantiation request to the determined VNFM, where the second VNF instantiation request is used to request the determined VNFM to instantiate the to-be-instantiated VNF.

The NFVO sends the second VNF instantiation request to the determined VNFM, so that the determined VNFM to instantiate the to-be-instantiated VNF. Optionally, the NFVO may further store a correspondence between the identifier of the to-be-instantiated VNF and an identifier of the determined VNFM. After the instantiation is completed, the VNFM is further configured to manage a life cycle of the to-be-instantiated VNF. Therefore, the correspondence between the VNF and the VNFM also needs to be used in a subsequent process.

Optionally, the first VNF instantiation request is the same as the second VNF instantiation request, or the first VNF instantiation request is different from the second VNF instantiation request. When the first VNF instantiation request is different from the second VNF instantiation request, after receiving the first VNF instantiation request, the NFVO may process the first VNF instantiation request to obtain the second VNF instantiation request.

According to the method in this embodiment, after receiving the first VNF instantiation request, the NFVO may determine, for the to-be-instantiated VNF based on the VNF instantiation request from the VNFMs in the management domain of the NFVO, a VNFM used to manage the VNFM. This resolves a prior-art problem that the NFVO cannot select the VNFM for the VNF when there are a plurality of VNFMs in the management domain of the NFVO.

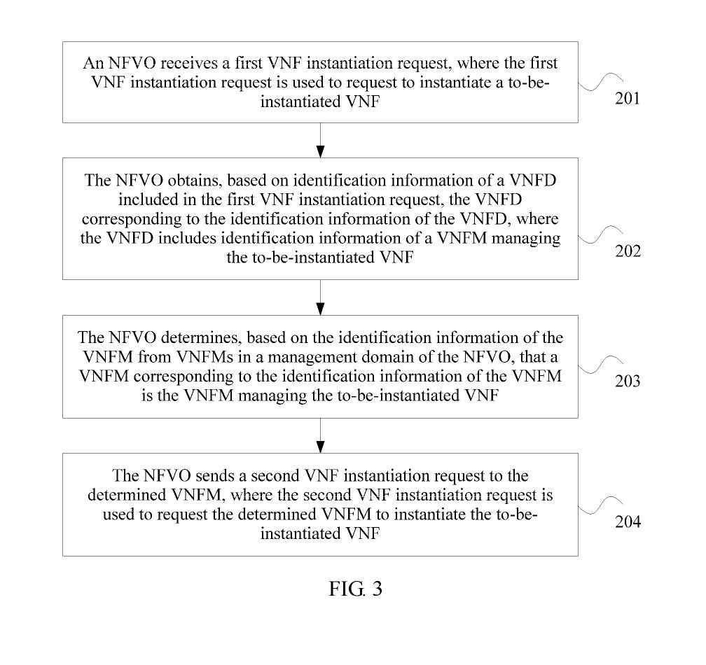

FIG. 3 is a flowchart of a VNFM determining method according to Embodiment 2 of the present disclosure. The method in this embodiment is mainly used for S-VNFM determining. As shown in FIG. 3, the method in this embodiment may include the following operations.

Operation 201: An NFVO receives a first VNF instantiation request, where the first VNF instantiation request is used to request to instantiate a to-be-instantiated VNF.

The VNF instantiation request includes identification information of a virtualized network function descriptor (VNFD), and the VNFD is used to instantiate the to-be-instantiated VNF.

Operation 202: The NFVO obtains, based on identification information of a VNFD included in the first VNF instantiation request, the VNFD corresponding to the identification information of the VNFD, where the VNFD includes identification information of a VNFM managing the to-be-instantiated VNF.

The NFVO may request, from an OSS, a BSS, or an EMS, to obtain the VNFD corresponding to the identification information of the VNFD. The VNFD includes the identification information of the VNFM of the to-be-instantiated VNF. The VNFD further includes other information, and only information related to this embodiment of the present disclosure is enumerated in this embodiment.

Table 1 describes information elements (Information Element, IE for short) included in the VNFD. As shown in Table 1, the VNFD includes five IEs in total: Attribute, Qualifier, Cardinality, Content, and Description. Values of the IEs are shown in Table 1. It may be seen from Table 1 that a function of an identifier of the VNFM of the to-be-instantiated VNF is described in the VNFD used to instantiate the to-be-instantiated VNF, that is, the identification information of the VNFM can uniquely identify one VNFM.

TABLE 1

| Attribute | Qualifier | Cardinality | Content | Description |
|---|---|---|---|---|
| vnfmId | M | 0 . . . N | Identifier | Unique identifier of the VNFM which |
| | | | | manages this VNF. |
| | | | | Only present if the VNF should be |
| | | | | managed by a vendor-specific VNFM. |

In this embodiment, the identification information of the VNFM managing the to-be-instantiated VNF includes: a first identifier or a second identifier that is of the VNFM of the to-be-instantiated VNF. The first identifier is generated by a vendor of the VNFM of the to-be-instantiated VNF according to a rule made by an operator, and the first identifier is used to uniquely identify the VNFM of the to-be-instantiated VNF in a management domain of the operator. That is, each operator makes a VNFM identifier generation rule, and then provides the VNFM identifier generation rule made by each operator for the vendor of the VNFM. When providing the VNFM for the operator, the vendor of the VNFM generates a VNFM identifier according to the VNFM identifier generation rule made by the operator. The first identifier can uniquely identify the VNFM only in the management domain of the operator, and some VNFM identifiers of different operators may be the same.

The second identifier is a universally unique identifier (UUID), and the second identifier is used to uniquely identify the VNFM globally.

Operation 203: The NFVO determines, based on the identification information of the VNFM from VNFMs in a management domain of the NFVO, that a VNFM corresponding to the identification information of the VNFM is the VNFM managing the to-be-instantiated VNF.

The NFVO stores identification information of each VNFM in the management domain of the NFVO. After obtaining the identification information of the VNFM of the to-be-instantiated VNF, the NFVO queries, based on the locally stored identification information of the VNFM, a VNFM corresponding to the obtained identification information of the VNFM managing the to-be-instantiated VNF, and determines the obtained VNFM as the VNFM managing the to-be-instantiated VNF.

It should be noted that the VNFD may include identification information of one or more VNFMs, that is, one or more VNFMs that can manage the to-be-instantiated VNF may exist in the management domain of the NFVO. When a plurality of VNFMs that can manage the to-be-instantiated VNF exist in the management domain of the NFVO, the VNFD may include identifiers of the plurality of VNFMs that can manage the to-be-instantiated VNF, and the NFVO may select, from a plurality of VNFMs according to a preset rule, one VNFM as the VNFM managing the to-be-instantiated VNF. For example, the NFVO may select, based on a load status of each VNFM, a VNFM with less load as the VNFM managing the to-be-instantiated VNF.

Operation 204: The NFVO sends a second VNF instantiation request to the determined VNFM, where the second VNF instantiation request is used to request the determined VNFM to instantiate the to-be-instantiated VNF.

According to the method in this embodiment, an identifier is set for each VNFM. When the NFVO receives the first VNF instantiation request, the NFVO obtains the VNFD, and determines the VNFM based on the VNFM identification information specified by the vendor of the VNF in the VNFD. This can ensure that a capability of the VNFM managing the VNF meets all requirements of the vendor of the VNF, thereby ensuring that VNF deployment and life cycle management are performed correctly and highly efficiently.

Based on Embodiment 2, optionally, the VNFD includes a third identifier of the VNFM of the to-be-instantiated VNF and vendor information of the to-be-instantiated VNF. The third identifier is generated by the vendor of the to-be-instantiated VNF according to the rule made by the vendor, and the third identifier is used to uniquely identify the VNFM in a management domain of the vendor. Each operator makes a VNFM identifier generation rule independently, and consequently, third identifiers of the VNFM in the management domain of different operators may be the same, and the third identifier cannot uniquely identify one VNFM in the management domain of the NFVO. Therefore, the VNFD further includes vendor information of the to-be-instantiated VNF. In an S-VNFM scenario, both the VNF and the VNFM are provided by the operator, a vendor of the VNF is a vendor of the VNFM, and therefore, one VNFM can be uniquely identified in the management domain of the NFVO based on the third identifier and the vendor of the VNF.

Correspondingly, the NFVO determines, based on the third identifier of the VNFM and the vendor information of the to-be-instantiated VNF from VNFMs in the management domain of the NFVO, the VNFM managing the to-be-instantiated VNF. The NFVO stores a third identifier of each VNFM in the management domain of the NFVO and vendor information of the VNF. The NFVO may determine, based on the third identifier of the VNFM managing the to-be-instantiated VNF and the vendor information of the to-be-instantiated VNF, the VNFM managing the to-be-instantiated VNF.

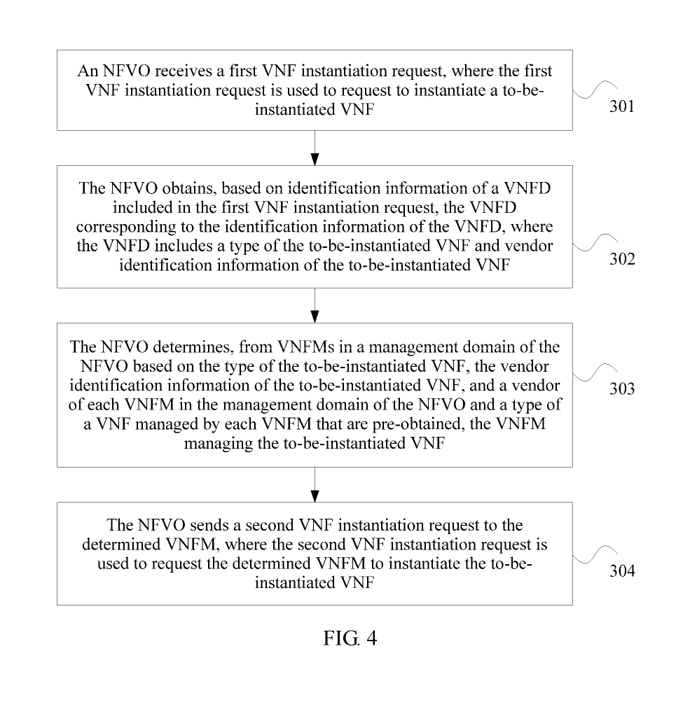

FIG. 4 is a flowchart of a VNFM determining method according to Embodiment 3 of the present disclosure. As shown in FIG. 4, the method in this embodiment may include the following operations.

Operation 301: An NFVO receives a first VNF instantiation request, where the first VNF instantiation request is used to request to instantiate a to-be-instantiated VNF.

In this embodiment, the first VNF instantiation request includes identification information of a VNFD that is used to instantiate the to-be-instantiated VNF.

Operation 302: The NFVO obtains, based on identification information of a VNFD included in the first VNF instantiation request, the VNFD corresponding to the identification information of the VNFD, where the VNFD includes a type of the to-be-instantiated VNF and vendor identification information of the to-be-instantiated VNF.

The VNFD includes the type of the to-be-instantiated VNF and the vendor identification information. The type of the VNF is defined by a vendor of the VNF, and the vendor of the VNF is a vendor providing the VNF. The type of the VNF may be a type of a network element such as an MME, a PGW, or another type such as an EPC network element or an IMS network element.

Table 2 describes IEs included in the VNFD. As shown in Table 2, the VNFD includes five IEs in total: Attribute, Qualifier, Cardinality, Content, and Description. Values of the IEs are shown in Table 2. It may be seen from Table 2 that a VNFD corresponding to the to-be-instantiated VNF describes a type and a vendor of the to-be-instantiated VNF.

TABLE 2

| Attribute | Qualifier | Cardinality | Content | Description |
|---|---|---|---|---|
| vendor | M | 1 | Identifier | The vendor generating this VNFD. |
| vnfType | M | 0 . . . 1 | String | The type of this VNF. |

Operation 303: The NFVO determines, from VNFMs in a management domain of the NFVO based on the type of the to-be-instantiated VNF, the vendor identification information of the to-be-instantiated VNF, and a vendor of each VNFM in the management domain of the NFVO and a type of a VNF managed by each VNFM that are pre-obtained, the VNFM managing the to-be-instantiated VNF.

In an S-VNFM deployment scenario, for the to-be-instantiated VNF, a vendor of the VNFM managing the to-be-instantiated VNF needs to be the same as that of the to-be-instantiated VNF, and the type of the to-be-instantiated VNF is one of types of the VNFs managed by the VNFM managing the to-be-instantiated VNF. Each VNFM may manage one or more types of VNFs.

In this embodiment, the NFVO may obtain the vendor of each VNFM in the management domain of the NFVO and the type of the VNF managed by each VNFM in the following two manners:

In an implementation, the type of the VNF managed by each VNFM in the management domain of the NFVO is pre-configured. When providing the VNFM, the vendor of the VNF indicates the type of the VNF that can be managed by the VNFM, and the NFVO records the vendor of the VNFM and the type of the VNF managed by the VNFM.

In another implementation, the NFVO queries, from each VNFM in the management domain, the type of the VNF managed by each VNFM; or the NFVO receives a type that is of a VNF managed by each VNFM and that is reported by each VNFM in the management domain.

It should be noted that each vendor may provide a plurality of VNFMs, and some types of VNFs managed by the plurality of VNFMs may be the same. Therefore, there may be a plurality of VNFMs, in the management domain of the NFVO, that are from a same vendor as that of the to-be-instantiated VNF and that manages a VNF whose type is the same as that of the to-be-instantiated VNF. When there are a plurality of VNFMs, in the management domain of the NFVO, that are from a same vendor as that of the to-be-instantiated VNF and that manages a VNF whose type is the same as that of the to-be-instantiated VNF, the NFVO may select, according to the preset rule from a plurality of VNFMs that meet a condition, one VNFM to manage the to-be-instantiated VNF. For example, the NFVO may select, based on a load status of each VNFM, a VNFM with less load as the VNFM managing the to-be-instantiated VNF.

Operation 304: The NFVO sends a second VNF instantiation request to the determined VNFM, where the second VNF instantiation request is used to request the determined VNFM to instantiate the to-be-instantiated VNF.

According to the method in this embodiment, the NFVO obtains the vendor of each VNFM in the management domain and the type of the VNF managed by each VNFM. When the NFVO receives the first VNF instantiation request, the NFVO obtains the VNFD, and determines, from the VNFMs in the management domain of the NFVO based on the type of the to-be-instantiated VNF included in the VNFD and vendor information, that a VNFM that is from a same vendor as that of the to-be-instantiated VNF and that manages a VNF whose type is the same as that of the to-be-instantiated VNF. The VNFM is determined based on the VNF type and the VNF vendor, and therefore, it can be ensured that the VNF type that can be managed by the selected VNFM matches the VNF type, and VNF deployment and VNF life cycle management are performed correctly and efficiently, and in addition, the NFVO may select one VNFM based on internal settings from several VNFMs meeting the requirements to implement load balancing between VNFMs.

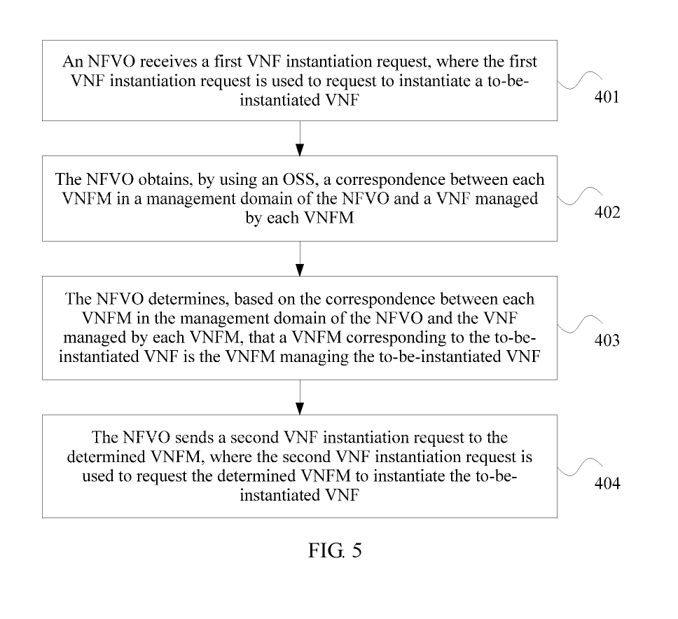

FIG. 5 is a flowchart of a VNFM determining method according to Embodiment 4 of the present disclosure. The method in this embodiment is mainly used for S-VNFM determining. As shown in FIG. 5, the method in this embodiment may include the following operations.

Operation 401: An NFVO receives a first VNF instantiation request, where the first VNF instantiation request is used to request to instantiate a to-be-instantiated VNF.

Operation 402: The NFVO obtains, by using an OSS, a correspondence between each VNFM in a management domain of the NFVO and a VNF managed by each VNFM.

In an implementation, the NFVO sends a VNFM capability query request to the OSS, where the VNFM capability query request is used to request to query the correspondence between each VNFM in the management domain of the NFVO and the VNF managed by each VNFM. The OSS stores the correspondence between the VNF and the VNFM managing the VNF. The correspondence may be collected by the OSS from an EMS, or sent by the EMS to the OSS. For one VNF, there may be only one VNFM that can manage the VNF, or there may be a plurality of VNFMs that can manage the VNF. After the OSS receives the VNFM capability query request sent by the NFVO, the correspondence between each VNFM in the management domain of the NFVO and the VNF managed by each VNFM is carried in a query response and is sent to the NFVO. The NFVO receives the query response returned by the OSS, and obtains the correspondence between each VNFM in the management domain of the NFVO and the VNF managed by each VNFM. The NFVO may periodically send the VNFM capability query request to the OSS, or may send the VNFM capability query request to the OSS when receiving the first VNF instantiation request.

In another implementation, the NFVO receives the correspondence that is reported by the OSS and that is between each VNFM in the management domain of the NFVO and the VNF managed by each VNFM. The OSS may periodically report the correspondence, or may report the correspondence when a triggering condition is met. For example, the OSS reports the correspondence only when the correspondence between each VNFM in the management domain of the NFVO and the VNF managed by each VNFM is updated.

It should be noted that there is no execution order between operation 401 and operation 402.

Operation 403: The NFVO determines, based on the correspondence between each VNFM in the management domain of the NFVO and the VNF managed by each VNFM, that a VNFM corresponding to the to-be-instantiated VNF is the VNFM managing the to-be-instantiated VNF.

Based on the correspondence, if there is only one VNFM that can manage the to-be-instantiated VNF, the NFVO directly determines the VNFM as the VNFM managing the to-be-instantiated VNF; or if there are a plurality of VNFMs that can manage the to-be-instantiated VNF, the NFVO selects, from the plurality of VNFMs, one VNFM managing the to-be-instantiated VNF.

Operation 404: The NFVO sends a second VNF instantiation request to the determined VNFM, where the second VNF instantiation request is used to request the determined VNFM to instantiate the to-be-instantiated VNF.

In this embodiment, the OSS stores the correspondence between each VNFM in the management domain of the NFVO and the VNF managed by each VNFM. When the NFVO obtains, by using the OSS, the correspondence between each VNFM in the management domain of the NFVO and the VNF managed by each VNFM, the NFVO determines, based on the correspondence between each VNFM in the management domain of the NFVO and the VNF managed by each VNFM, the VNFM that is used to manage the to-be-instantiated VNF. Based on the correspondence that is between the VNFM and the VNF and that is stored by the OSS, it may be ensured that the VNFM selected by the NFVO for the to-be-instantiated VNF meets service and virtualization deployment requirements of the OSS on the operator.

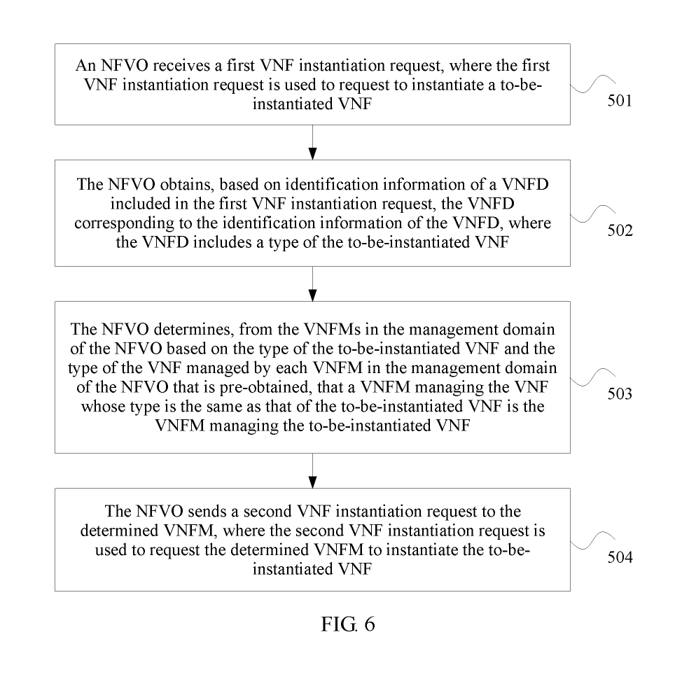

FIG. 6 is a flowchart of a VNFM determining method according to Embodiment 5 of the present disclosure. As shown in FIG. 6, the method in this embodiment may include the following operations.

Operation 501: An NFVO receives a first VNF instantiation request, where the first VNF instantiation request is used to request to instantiate a to-be-instantiated VNF.

In this embodiment, the first VNF instantiation request includes identification information of a VNFD that is used to instantiate the to-be-instantiated VNF.

Operation 502: The NFVO obtains, based on identification information of a VNFD included in the first VNF instantiation request, the VNFD corresponding to the identification information of the VNFD, where the VNFD includes a type of the to-be-instantiated VNF.

The type of the VNF is defined by a vendor of the VNF. The type of the VNF may be a type of a network element such as an MME or a PGW, or another type such as an EPC network element or an IMS network element.

Table 3 describes IEs included in the VNFD. It may be seen from Table 3 that the VNFD used to instantiate the to-be-instantiated VNF describes the type of the to-be-instantiated VNF.

TABLE 3

| Attribute | Qualifier | Cardinality | Content | Description |
|---|---|---|---|---|
| vnfType | M | 0 . . . 1 | String | The type of this VNF. |

Operation 503: The NFVO determines, from the VNFMs in the management domain of the NFVO based on the type of the to-be-instantiated VNF and the type of the VNF managed by each VNFM in the management domain of the NFVO that is pre-obtained, that a VNFM managing the VNF whose type is the same as that of the to-be-instantiated VNF is the VNFM managing the to-be-instantiated VNF.

In this embodiment, the type of the VNF managed by the determined VNFM needs to include the type of the to-be-instantiated VNF.

In this embodiment, the NFVO may obtain the type of the VNF managed by each VNFM in the management domain of the NFVO in the following two manners:

In an implementation, the type of the VNF managed by each VNFM in the management domain of the NFVO is pre-configured. When providing the VNFM, the vendor of the VNFM indicates the type of the VNF that can be managed by the VNFM, and the NFVO records the type of the VNF managed by the VNFM.

In another implementation, the NFVO queries, from each VNFM in the management domain of the NFVO, the type of the VNF managed by each VNFM; or the NFVO receives a type that is of a VNF managed by each VNFM and that is reported by each VNFM in the management domain of the NFVO.

It should be noted that some types of VNFs managed by a plurality of VNFMs in the management domain of the NFVO may be the same. Therefore, in the management domain of the NFVO, the type of the VNF managed by a plurality of VNFMs may be the same as that of the to-be-instantiated VNF. In the management domain of the NFVO, when the type of the VNF managed by a plurality of VNFMs is the same as that of the to-be-instantiated VNF, the NFVO may select, according to a preset rule from a plurality of VNFMs that meet a condition, one VNFM to manage the to-be-instantiated VNF.

Operation 504: The NFVO sends a second VNF instantiation request to the determined VNFM, where the second VNF instantiation request is used to request the determined VNFM to instantiate the to-be-instantiated VNF.

According to the method in this embodiment, the NFVO obtains the type of the VNF managed by each VNFM in the management domain. When the NFVO receives the first VNF instantiation request, the NFVO obtains the VNFD, and determines, from the VNFMs in the management domain of the NFVO based on the type of the to-be-instantiated VNF included in the VNFD, that a VNFM managing the VNF whose type is the same as that of the to-be-instantiated VNF is the VNFM managing the to-be-instantiated VNF. The method can ensure that in a G-VNFM scenario, a capability of the VNFM selected for the VNF matches the VNF type, and VNF life cycle management is performed correctly and efficiently.

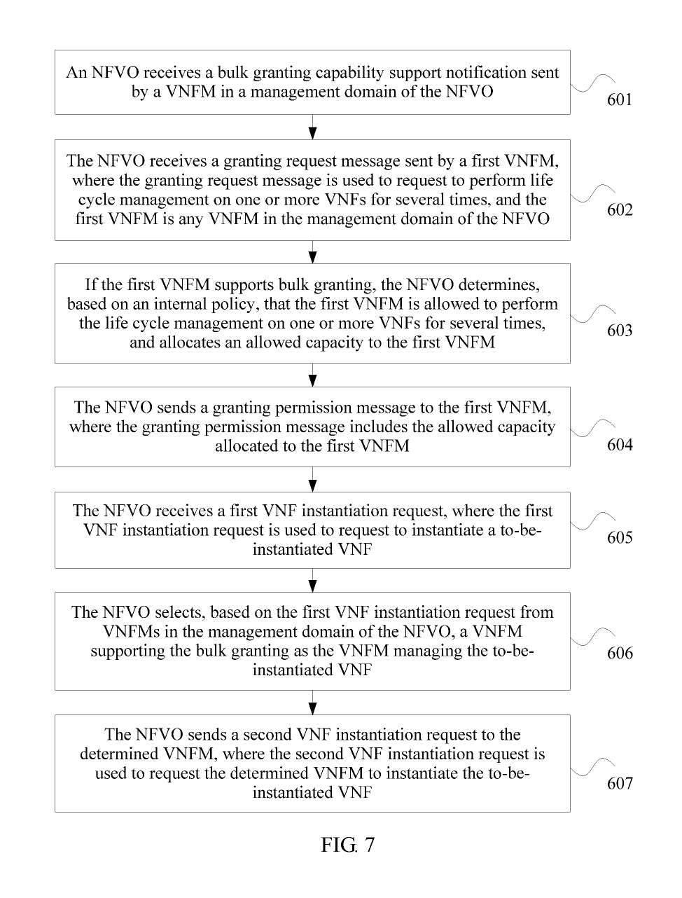

FIG. 7 is a flowchart of a VNFM determining method according to Embodiment 6 of the present disclosure. In this embodiment, the VNFM is determined mainly based on related features of NFVO bulk granting. A VNF life cycle operation granting function is a basic mechanism in the NFVO. Based on the mechanism, the NFVO allows the VNFM to perform a life cycle management operation and a resource management operation on a VNF. Every time before performing the VNF life cycle management operation, the VNFM sends a granting request to the NFVO, and the NFVO determines, based on an internal policy and a current resource status, whether to perform granting on the VNFM. As an enhancement and an extension based on granting, bulk granting allows the VNFM to apply to the NFVO for performing the VNF life cycle management operation on one or more VNFs for several times, with no need to send the granting request to the NFVO every time before performing the VNF life cycle management operation. As shown in FIG. 7, the method in this embodiment may include the following operations.

Operation 601: The NFVO receives a bulk granting capability support notification sent by the VNFM in a management domain of the NFVO.

Operation 602: The NFVO receives a granting request message sent by a first VNFM, where the granting request message is used to request to perform life cycle management on one or more VNFs for several times, and the first VNFM is any VNFM in the management domain of the NFVO.

Operation 603: If the first VNFM supports bulk granting, the NFVO determines, based on the internal policy, that the first VNFM is allowed to perform the life cycle management on one or more VNFs for several times, and allocates an allowed capacity (permitted allowance) to the first VNFM.

Operation 604: The NFVO sends a granting permission message to the first VNFM, where the granting permission message includes the allowed capacity allocated to the first VNFM.

After receiving the granting permission message, the first VNFM may perform life cycle management on a corresponding VNF.

Operation 605: The NFVO receives a first VNF instantiation request, where the first VNF instantiation request is used to request to instantiate a to-be-instantiated VNF.

Operation 606: The NFVO selects, according to the first VNF instantiation request from VNFMs in the management domain of the NFVO, a VNFM supporting the bulk granting as the VNFM managing the to-be-instantiated VNF.

If only one VNFM in the management domain of the NFVO meets the following condition: the NFVO has allowed the VNFM to perform the life cycle management on one or more VNFs for several times, and the VNFM supports the bulk granting, the NFVO determines that the VNFM is the VNFM managing the to-be-instantiated VNF.

If a plurality of VNFMs in the management domain of the NFVO meet the foregoing condition, the NFVO determines, from VNFMs in the management domain of the NFVO, at least two backup VNFMs supporting the bulk granting; and then the NFVO selects, based on an available capacity of the at least two backup VNFMs, a VNFM from the at least two backup VNFMs as the VNFM managing the to-be-instantiated VNF. The NFVO may select a VNFM with a relatively large available capacity as the VNFM managing the to-be-instantiated VNF. An available capacity of the backup VNFM is equal to a remaining capacity obtained by subtracting a used capacity from the allowed capacity allocated by the NFVO.

Operation 607: The NFVO sends a second VNF instantiation request to the determined VNFM, where the second VNF instantiation request is used to request the determined VNFM to instantiate the to-be-instantiated VNF.

According to the method in this embodiment, the NFVO performs granting, in the bulk granting manner, on the VNFM for performing the life cycle management on one or more VNFs for several times. When the NFVO receives the first VNF instantiation request, the NFVO selects, from VNFMs in the management domain of the NFVO, one VNFM supporting the bulk granting as the VNFM managing the to-be-instantiated VNF. The selected VNFM can support the bulk granting, and has performed the life cycle management on the VNF for several times, thereby improving VNF life cycle management efficiency, and ensuring consistency of policies of the NFVO and the VNFM.

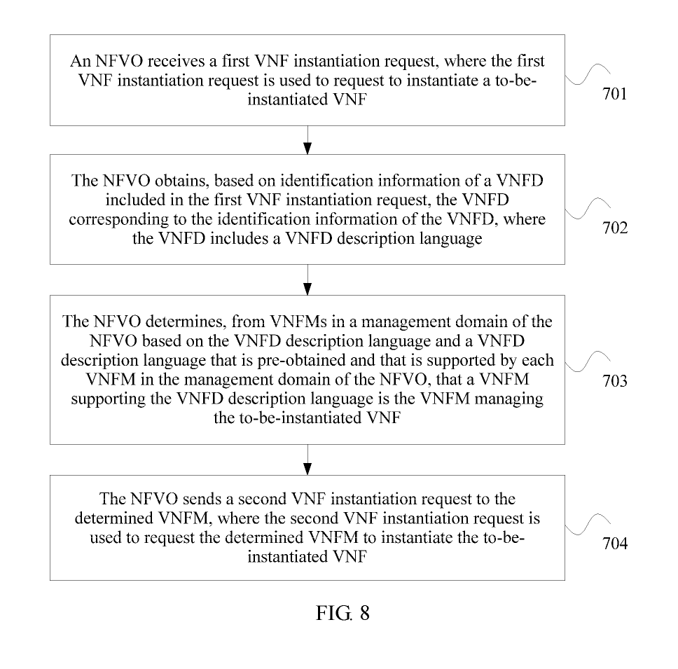

FIG. 8 is a flowchart of a VNFM determining method according to Embodiment 7 of the present disclosure. As shown in FIG. 8, the method in this embodiment may include the following operations.

Operation 701: An NFVO receives a first VNF instantiation request, where the first VNF instantiation request is used to request to instantiate a to-be-instantiated VNF.

Operation 702: The NFVO obtains, based on identification information of a VNFD included in the first VNF instantiation request, the VNFD corresponding to the identification information of the VNFD, where the VNFD includes a VNFD description language.

Operation 703: The NFVO determines, from VNFMs in a management domain of the NFVO based on the VNFD description language and a VNFD description language that is pre-obtained and that is supported by each VNFM in the management domain of the NFVO, that a VNFM supporting the VNFD description language is the VNFM managing the to-be-instantiated VNF.

The NFVO pre-obtains the VNFD description language that is supported by each VNFM in the management domain. After obtaining the VNFD description language from the VNFD, the NFVO selects, based on the VNFD description language from the management domain, the VNFM supporting the VNFD description language as the VNFM managing the to-be-instantiated VNF.

The NFVO may obtain the VNFD description language supported by each VNFM in the following manner: The NFVO queries, from each VNFM in the management domain, the VNFD description language supported by each VNFM; or the NFVO receives the VNFD description language that is reported by each VNFM and that is supported by each VNFM.

Operation 704: The NFVO sends a second VNF instantiation request to the determined VNFM, where the second VNF instantiation request is used to request the determined VNFM to instantiate the to-be-instantiated VNF.

In this embodiment, the NFVO pre-obtains the VNFD description language that is supported by each VNFM in the management domain. When receiving the first VNF instantiation request, the NFVO obtains the VNFD, where the VNFD includes the VNFD description language, and selects, from VNFMs in the management domain based on the VNFD description language included in the VNFD, a VNFM whose VNFD description language is the same as that included in the VNFD as the VNFM managing the to-be-instantiated VNF. The determined VNFM can support the VNFD description language, and therefore, it can be ensured that the VNFM reads and understands content described by the VNFD, and obtains a VNF deployment requirement, thereby ensuring that VNF deployment and life cycle management are performed correctly.

It should be noted that in the foregoing Embodiment 1 to Embodiment 7, the NFVO may alternatively receive an NS instantiation request sent by the OSS or the BSS. The NS instantiation request is used to request to instantiate a to-be-instantiated NS, and one NS includes one or more VNFs. Instantiating the to-be-instantiated NS is equivalent to instantiating VNFs included in the to-be-instantiated NS. Therefore, when the OSS or the BSS needs to instantiate the VNF, the VNF instantiation request or the NS instantiation request may be sent to the NFVO. The NFVO determines, based on the NS instantiation request, the to-be-instantiated VNF included in the to-be-instantiated NS and corresponding parameters such as identification information of a VNFD used to instantiate the to-be-instantiated VNF, an identifier of the to-be-instantiated VNF, a type of the to-be-instantiated VNF, and virtual resources required by the to-be-instantiated VNF (a computing resource, a storage resource, and a network resource).

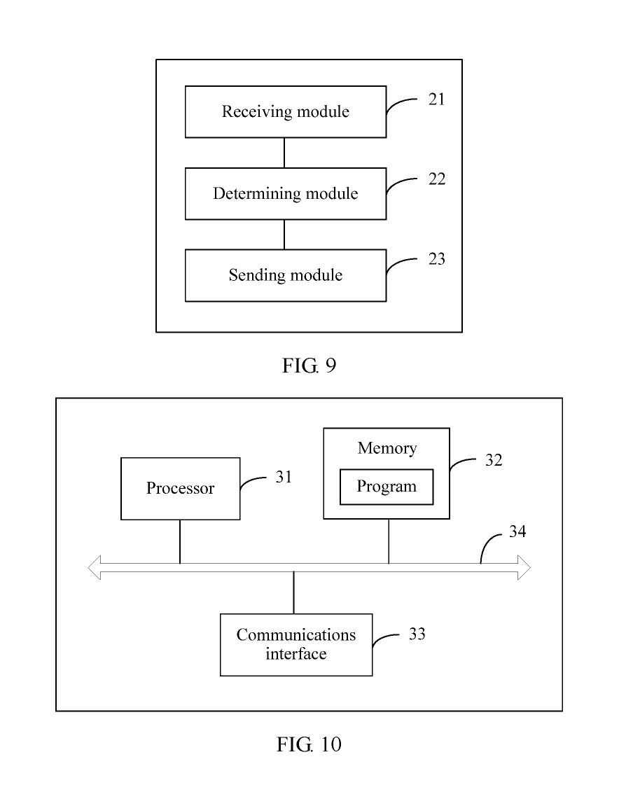

FIG. 9 is a schematic structural diagram of an NFVO according to Embodiment 8 of the present disclosure. As shown in FIG. 9, the NFVO includes: a receiving module 21, a determining module 22, and a sending module 23.

The receiving module 21 is configured to receive a first VNF instantiation request, where the first VNF instantiation request is used to request to instantiate a to-be-instantiated VNF.

The determining module 22 is configured to determine, from VNFMs in a management domain of the NFVO according to the first VNF instantiation request received by the receiving module 21, a VNFM managing the to-be-instantiated VNF.

The sending module 23 is configured to send a second VNF instantiation request to the VNFM determined by the determined module 22, where the second VNF instantiation request is used to request the determined VNFM to instantiate the to-be-instantiated VNF.

Function modules of the NFVO provided in this embodiment may be configured to perform the methods in Embodiment 1 to Embodiment 7. A implementation and a technical effect thereof are similar to those of the methods in Embodiment 1 to Embodiment 7, and reference may be made to related description of Embodiment 1 to Embodiment 7.

FIG. 10 is a schematic structural diagram of an NFVO according to Embodiment 9 of the present disclosure. As shown in FIG. 10, the NFVO includes: a processor 31, a memory 32, and a communications interface 33. The memory 32 is configured to store a program, and the communications interface 33 and the memory 32 are connected to the processor 31 by using a bus 34.

The communications interface 33 is configured to receive a first VNF instantiation request, where the first VNF instantiation request is used to request to instantiate a to-be-instantiated VNF.

The processor 31 is configured to determine, according to the first VNF instantiation request from VNFMs in a management domain of the NFVO, a VNFM managing a to-be-instantiated VNF.

The communications interface 33 is further configured to send a second VNF instantiation request to the determined VNFM, where the second VNF instantiation request is used to request the determined VNFM to instantiate the to-be-instantiated VNF.

Optionally, the processor 31 is configured to: obtain, based on identification information of a VNFD included in the first VNF instantiation request, the VNFD corresponding to the identification information of the VNFD; and determine, from the VNFMs in the management domain of the NFVO based on the identification information of the VNFM managing the to-be-instantiated VNF included in the VNFD, that a VNFM corresponding to the identification information of the VNFM is the VNFM managing the to-be-instantiated VNF.

Optionally, the processor 31 is configured to: obtain, based on identification information of a VNFD that is included in the first VNF instantiation request and that is used to instantiate the to-be-instantiated VNF, the VNFD corresponding to the identification information of the VNFD; and determine, based on a third identifier of the to-be-instantiated VNF included in the VNFD and vendor information of the to-be-instantiated VNF from the VNFMs in the management domain of the NFVO, the VNFM managing the to-be-instantiated VNF, where the third identifier is used to uniquely identify the VNFM of the to-be-instantiated VNF in a management domain of the vendor.

Optionally, the processor 31 is configured to: obtain, based on identification information of a VNFD that is included in the first VNF instantiation request, the VNFD corresponding to the identification information of the VNFD; and determine, from the VNFMs in the management domain of the NFVO based on a type of the to-be-instantiated VNF and the vendor identification information of the to-be-instantiated VNF that are included in the VNFD, and a vendor of each VNFM in the management domain of the NFVO and a type of a VNF managed by each VNFM that are pre-obtained, the VNFM managing the to-be-instantiated VNF.

Optionally, the processor 31 is configured to: obtain, based on identification information of a VNFD that is included in the first VNF instantiation request and that is used to instantiate the to-be-instantiated VNF, the VNFD corresponding to the identification information of the VNFD; and determine, from the VNFMs in the management domain of the NFVO based on the type of the to-be-instantiated VNF included in the VNFD and the type of the VNF managed by each VNFM in the management domain of the NFVO that is pre-obtained, that a VNFM managing the VNF whose type is the same as that of the to-be-instantiated VNF is the VNFM managing the to-be-instantiated VNF.

Optionally, the processor 31 is configured to: obtain, by using an OSS, a correspondence between each VNFM in the management domain of the NFVO and the VNF managed by each VNFM; and determine, based on the correspondence between each VNFM in the management domain of the NFVO and the VNF managed by each VNFM, that a VNFM corresponding to the to-be-instantiated VNF is the VNFM managing the to-be-instantiated VNF.

Optionally, the processor 31 is configured to: select, according to the first VNF instantiation request from VNFMs in the management domain of the NFVO, a VNFM that supports bulk granting as the VNFM managing the to-be-instantiated VNF.

Optionally, the processor 31 is configured to: obtain, based on identification information of a VNFD that is included in the first VNF instantiation request, the VNFD corresponding to the identification information of the VNFD; and determine, from the VNFMs in the management domain of the NFVO based on a VNFD description language included in the VNFD and a VNFD description language that is pre-obtained and that is supported by each VNFM in the management domain of the NFVO, that a VNFM supporting the VNFD description language is the VNFM managing the to-be-instantiated VNF.

The NFVO provided in this embodiment may be configured to perform the methods in Embodiment 1 to Embodiment 7. An implementation and a technical effect thereof are similar to those of the methods in Embodiment 1 to Embodiment 7, and reference may be made to related description of Embodiment 1 to Embodiment 7.

Finally, it should be noted that the foregoing embodiments are merely intended for describing the technical solutions of the present disclosure, but not for limiting the present disclosure. Although the present disclosure is described in detail with reference to the foregoing embodiments, a person of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A virtualized network function manager (VNFM) determining method, comprising:
receiving, by a network functions virtualization orchestrator (NFVO), a first virtualized network function (VNF) instantiation request, wherein the first VNF instantiation request is for requesting to instantiate a to-be-instantiated VNF;
determining, by the NFVO according to the first VNF instantiation request, a VNFM managing the to-be-instantiated VNF from a plurality of VNFMs in a management domain of the NFVO; and
sending, by the NFVO, a second VNF instantiation request to the determined VNFM, wherein the second VNF instantiation request is for requesting the determined VNFM to instantiate the to-be-instantiated VNF.

2. The method according to claim 1, wherein the determining, by the NFVO according to the first VNF instantiation request, a VNFM managing the to-be-instantiated VNF from the plurality of VNFMs in a management domain of the NFVO comprises:
obtaining, by the NFVO based on identification information of a virtualized network function descriptor (VNFD), the VNFD corresponding to the identification information of the VNFD, wherein the first VNF instantiation request comprises the identification information of the VNFD, and the VNFD comprises identification information of the VNFM managing the to-be-instantiated VNF; and
determining, by the NFVO based on the identification information of the VNFM from the plurality of VNFMs in the management domain of the NFVO, that a VNFM corresponding to the identification information of the VNFM is the VNFM managing the to-be-instantiated VNF.

3. The method according to claim 2, wherein the identification information of the VNFM comprises:
a first identifier of the VNFM, wherein the first identifier is for uniquely identifying the VNFM in the management domain of an operator; or
a second identifier of the VNFM, wherein the second identifier is a universally unique identifier (UUID), and the second identifier is for uniquely identifying the VNFM globally.

4. The method according to claim 1, wherein the determining, by the NFVO according to the first VNF instantiation request, the VNFM managing the to-be-instantiated VNF from the plurality of VNFMs in a management domain of the NFVO comprises:
obtaining, by the NFVO based on identification information of a virtualized network function descriptor (VNFD), the VNFD corresponding to the identification information of the VNFD, wherein the first VNF instantiation request comprises the identification information of the VNFD, and the VNFD comprises a third identifier of the VNFM managing the to-be-instantiated VNF and vendor information of the to-be-instantiated VNF, and the third identifier is for uniquely identifying the VNFM in a management domain of the vendor; and
determining, by the NFVO based on the third identifier of the to-be-instantiated VNF and the vendor information of the to-be-instantiated VNF from the VNFMs in the management domain of the NFVO, the VNFM managing the to-be-instantiated VNF.

5. The method according to claim 1, wherein the determining, by the NFVO according to the first VNF instantiation request, the VNFM managing the to-be-instantiated VNF from the plurality of VNFMs in a management domain of the NFVO comprises:
obtaining, by the NFVO based on identification information of a virtualized network function descriptor (VNFD), the VNFD corresponding to the identification information of the VNFD, wherein the first VNF instantiation request comprises the identification information of the VNFD, and the VNFD comprises a type of the to-be-instantiated VNF and vendor identification information of the to-be-instantiated VNF; and
determining, by the NFVO based on the type of the to-be-instantiated VNF, the vendor identification information of the to-be-instantiated VNF, a pre-obtained vendor of each VNFM in the management domain of the NFVO, and a pre-obtained type of a VNF managed by each VNFM, the VNFM managing the to-be-instantiated VNF from the plurality of VNFMs in the management domain of the NFVO.

6. The method according to claim 1, wherein the determining, by the NFVO according to the first VNF instantiation request, the VNFM managing the to-be-instantiated VNF from the plurality of VNFMs in a management domain of the NFVO comprises:
obtaining, by the NFVO based on identification information of a virtualized network function descriptor (VNFD), the VNFD corresponding to the identification information of the VNFD, wherein the first VNF instantiation request comprises the identification information of the VNFD, and the VNFD comprises a type of the to-be-instantiated VNF; and
determining, by the NFVO from the plurality of VNFMs in the management domain of the NFVO based on the type of the to-be-instantiated VNF and the pre-obtained type of the VNF managed by each VNFM in the management domain of the NFVO, that a VNFM managing the VNF whose type is the same as that of the to-be-instantiated VNF is the VNFM managing the to-be-instantiated VNF.

7. The method according to claim 1, wherein the determining, by the NFVO according to the first VNF instantiation request, the VNFM managing the to-be-instantiated VNF from plurality of VNFMs in a management domain of the NFVO comprises:
obtaining, by the NFVO through an operation support system (OSS), a correspondence between each VNFM in the management domain of the NFVO and the VNF managed by each VNFM; and
determining, by the NFVO based on the correspondence between each VNFM in the management domain of the NFVO and the VNF managed by each VNFM, that a VNFM corresponding to the to-be-instantiated VNF is the VNFM managing the to-be-instantiated VNF.

8. The method according to claim 7, wherein the obtaining, by the NFVO through an operation support system (OSS), a correspondence between each VNFM in the management domain of the NFVO and the VNF managed by each VNFM comprises:
sending, by the NFVO, a VNFM capability query request to the OSS, wherein the VNFM capability query request is for requesting to query the correspondence between each VNFM in the management domain of the NFVO and the VNF managed by each VNFM; and
receiving, by the NFVO, a query response returned by the OSS, wherein the query response comprises the correspondence between each VNFM in the management domain of the NFVO and the VNF managed by each VNFM.

9. The method according to claim 7, wherein the obtaining, by the NFVO through an operation support system (OSS), a correspondence between each VNFM in the management domain of the NFVO and the VNF managed by each VNFM comprises:
receiving, by the NFVO, the correspondence that is reported by the OSS and that is between each VNFM in the management domain of the NFVO and the VNF managed by each VNFM.

10. The method according to claim 1, wherein the determining, by the NFVO according to the first VNF instantiation request, the VNFM managing the to-be-instantiated VNF from the plurality of VNFMs in a management domain of the NFVO comprises:
selecting, by the NFVO according to the first VNF instantiation request from the plurality of VNFMs in the management domain of the NFVO, a VNFM supporting bulk granting as the VNFM managing the to-be-instantiated VNF.

11. The method according to claim 10, wherein the selecting, by the NFVO based on the first VNF instantiation request from the plurality of VNFMs in the management domain of the NFVO, a VNFM supporting bulk granting as the VNFM managing the to-be-instantiated VNF comprises:
determining, by the NFVO from the plurality of VNFMs in the management domain of the NFVO, at least two backup VNFMs supporting the bulk granting; and
selecting, by the NFVO based on an available capacity of the at least two backup VNFMs, a VNFM from the at least two backup VNFMs as the VNFM managing the to-be-instantiated VNF.

12. The method according to claim 1, wherein the determining, by the NFVO according to the first VNF instantiation request, a VNFM managing the to-be-instantiated VNF from the plurality of VNFMs in a management domain of the NFVO comprises:
obtaining, by the NFVO based on identification information of a virtualized network function descriptor (VNFD), the VNFD corresponding to the identification information of the VNFD, wherein the first VNF instantiation request comprises the identification information of the VNFD, and the VNFD comprises a VNFD description language; and
determining, by the NFVO from the plurality of VNFMs in the management domain of the NFVO based on the VNFD description language and a VNFD description language that is pre-obtained and that is supported by each VNFM in the management domain of the NFVO, that a VNFM supporting the VNFD description language is the VNFM managing the to-be-instantiated VNF.

13. A network functions virtualization orchestrator (NFVO), comprising a processor and a communications interface, wherein
the communications interface is configured to receive a first virtualized network function (VNF) instantiation request, wherein the first VNF instantiation request is for requesting to instantiate a to-be-instantiated VNF;
the processor is configured to determine, according to the first VNF instantiation request, a virtualized network function manager (VNFM) managing the to-be-instantiated VNF from VNFMs in a management domain of the NFVO; and
the communications interface is further configured to send a second VNF instantiation request to the determined VNFM, wherein the second VNF instantiation request is for requesting the determined VNFM to instantiate the to-be-instantiated VNF.

14. The NFVO according to claim 13, wherein the processor is further configured to:
obtain, based on identification information of a virtualized network function descriptor (VNFD) comprised in the first VNF instantiation request, the VNFD corresponding to the identification information of the VNFD, wherein the first VNF instantiation request comprises the identification information of the VNFD, and the VNFD comprises identification information of the VNFM managing the to-be-instantiated VNF; and
determining, based on the identification information of the VNFM from the VNFMs in the management domain of the NFVO, that a VNFM corresponding to the identification information of the VNFM is the VNFM managing the to-be-instantiated VNF.

15. The NFVO according to claim 13, wherein the processor is further configured to:
obtain, based on identification information of a virtualized network function descriptor (VNFD), the VNFD corresponding to the identification information of the VNFD, wherein the first VNF instantiation request comprises the identification information of the VNFD, and the VNFD comprises a third identifier of the VNFM managing the to-be-instantiated VNF and vendor information of the to-be-instantiated VNF, and the third identifier is for uniquely identifying the VNFM of the to-be-instantiated VNF in a management domain of the vendor; and
determine, based on the third identifier of the to-be-instantiated VNF and the vendor information of the to-be-instantiated VNF from the VNFMs in the management domain of the NFVO, the VNFM managing the to-be-instantiated VNF.

16. The NFVO according to claim 13, wherein the processor is further configured to:
obtain, based on identification information of a virtualized network function descriptor (VNFD), the VNFD corresponding to the identification information of the VNFD, wherein the first VNF instantiation request comprises the identification information of the VNFD, and the VNFD comprises a type of the to-be-instantiated VNF and vendor identification information of the to-be-instantiated VNF; and
determine, based on the type of the to-be-instantiated VNF, the vendor identification information of the to-be-instantiated VNF, a pre-obtained vendor of each VNFM in the management domain of the NFVO, and a pre-obtained type of a VNF managed by each VNFM, the VNFM managing the to-be-instantiated VNF from the plurality of VNFMs in the management domain of the NFVO.

17. The NFVO according to claim 13, wherein the processor is further configured to:
obtain, based on identification information of a virtualized network function descriptor (VNFD), the VNFD corresponding to the identification information of the VNFD, wherein the first VNF instantiation request comprises the identification information of the VNFD, and the VNFD comprises a type of the to-be-instantiated VNF; and
determine, from the plurality of VNFMs in the management domain of the NFVO based on the type of the to-be-instantiated VNF and the pre-obtained type of the VNF managed by each VNFM in the management domain of the NFVO, that a VNFM managing the VNF whose type is the same as that of the to-be-instantiated VNF is the VNFM managing the to-be-instantiated VNF.

18. The NFVO according to claim 13, wherein the processor is further configured to:
obtain, through an operation support system (OSS), a correspondence between each VNFM in the management domain of the NFVO and the VNF managed by each VNFM; and
determine, based on the correspondence between each VNFM in the management domain of the NFVO and the VNF managed by each VNFM, that a VNFM corresponding to the to-be-instantiated VNF is the VNFM managing the to-be-instantiated VNF.

19. The NFVO according to claim 13, wherein the processor is further configured to:
select, according to the first VNF instantiation request from VNFMs in the management domain of the NFVO, a VNFM supporting bulk granting as the VNFM managing the to-be-instantiated VNF.

20. The NFVO according to claim 13, wherein the processor is further configured to:
obtain, based on identification information of a virtualized network function descriptor (VNFD), the VNFD corresponding to the identification information of the VNFD, wherein the first VNF instantiation request comprises the identification information of the VNFD, and the VNFD comprises a VNFD description language; and
determine, from the VNFMs in the management domain of the NFVO based on the VNFD description language and a VNFD description language that is pre-obtained and that is supported by each VNFM in the management domain of the NFVO, that a VNFM supporting the VNFD description language is the VNFM managing the to-be-instantiated VNF.
